(19) United States
(12) Patent Application Publication
(10) Pub. No.: US 2009/0112570 A1
(43) Pub. Date: Apr. 30, 2009

(54) DECLARATIVE MODEL INTERPRETATION

(75) Inventors: Antony Scott Williams, Mercer Island, WA (US); Siddharth Jayadevan, Seattle, WA (US); Arye Gittelman, Mercer Island, WA (US); William E. Aitken, Mercer Island, UT (US); Simon D. Kent, Redmond, WA (US); Vladimir Nedkov Hristov, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond (US)

(21) Appl. No.: 11/925,741

(22) Filed: Oct. 26, 2007

(51) Int. Cl. G06F 9/455

(52) U.S. Cl. 703/23

(57) ABSTRACT

Embodiments described herein are directed to the constructing software applications based on data models and automatically reconfiguring runtime object graphs according to data model edits input by a user. In one embodiment, a computer system performs a method for constructing at least a portion of a software application based on a data model. The computer system accesses a data model that includes user-configurable construction information indicating how at least a portion of a software application is to be constructed. The declarative interpreter is configured to construct an application based on the construction information in the data model. The computer system interprets the construction information in the data model to determine how to construct at least a portion of the software application. The computer system also constructs at least a portion of the software application based on the interpretation of the construction information in the data model.

### BACKGROUND

Computers have become highly integrated in the workforce, in the home, and in mobile devices. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications can be used to generate, edit and display data in the form of models. For example, models may be used by businesses and other entities to describe entities, processes, systems and other information. Some models may be referred to as flow diagrams, process flows, flowcharts, process diagrams and/or control charts. Others may be referred to as lists, tables, pie charts, or other forms of categorizing and displaying data. In some cases, models may be used to illustrate organizational relationships between resources in a system. These models are often referred to as organizational charts. In a broader sense, models may be used to show any type of relationship information between different objects.

Many times, however, software programs configured to interpret data models are limited to interpreting certain types of models. For example, such software programs are often hard-coded to be able to interpret certain types of data models, or certain instances of data models. However, when a data model changes, the interpreter is often unable to interpret the new and different instances of the data model. For instance, a user may edit a model to change various aspects of a software application based on the model such as the application's user interface or other functionality. Typical interpreters pre-programmed to handle certain changes may not be able to handle the changes input by the user. Thus, the changes will either not be implemented or the interpreter will fail to interpret the new instance of the data model. Thus, computer-run software applications used to interpret data models may be limited in their ability to interpret data models after changes have been applied.

### BRIEF SUMMARY

Embodiments described herein are directed to the constructing software applications based on data models and automatically reconfiguring runtime object graphs according to data model edits input by a user. In one embodiment, a computer system performs a method for constructing at least a portion of a software application based on a data model. The computer system accesses a data model that includes user-configurable construction information indicating how at least a portion of a software application is to be constructed. The declarative interpreter is configured to construct an application based on the user-configurable construction information in the data model. The computer system interprets the user-configurable construction information in the data model to determine how to construct at least a portion of the software application. The computer system also constructs at least a portion of the software application based on the interpretation of the user-configurable construction information in the data model.

In other embodiments, a computer system accesses a data model that includes construction information indicating how at least a portion of a software application is to be constructed. The computer system constructs a runtime object graph based on the construction information in the data model. The computer system presents a view of the software application based on the runtime object graph. The computer system receives a user input including one or more edits configured to perform changes on the data model. The computer system also automatically reconfigures the runtime object graph based on the edits such that the runtime object graph reflects the changes input by the user as indicated in the edits.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including constructing a software application based on data models and automatically reconfiguring a runtime object graph according to data model edits input by a user.

FIG. 2 illustrates a flowchart of an example method for constructing at least a portion of a software application based on data models.

FIG. 3 illustrates a flowchart of an example method for automatically reconfiguring a runtime object graph according to data model edits input by a user.

### DETAILED DESCRIPTION

Embodiments described herein are directed to the constructing software applications based on data models and automatically reconfiguring runtime object graphs according to data model edits input by a user. In one embodiment, a computer system performs a method for constructing at least a portion of a software application based on a data model. The computer system accesses a data model that includes construction information indicating how at least a portion of a software application is to be constructed. The declarative interpreter is configured to construct an application based on the construction information in the data model. The computer system interprets the construction information in the data model to determine how to construct at least a portion of the software application. The computer system also constructs at least a portion of the software application based on the interpretation of the construction information in the data model.

In other embodiments, a computer system accesses a data model that includes construction information indicating how at least a portion of a software application is to be constructed. The computer system constructs a runtime object graph based on the construction information in the data model. The computer system presents a view of the software application based on the runtime object graph. The computer system receives a user input including one or more edits configured to perform changes on the data model. The computer system also automatically reconfigures the runtime object graph based on the edits such that the runtime object graph reflects the changes input by the user as indicated in the edits.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

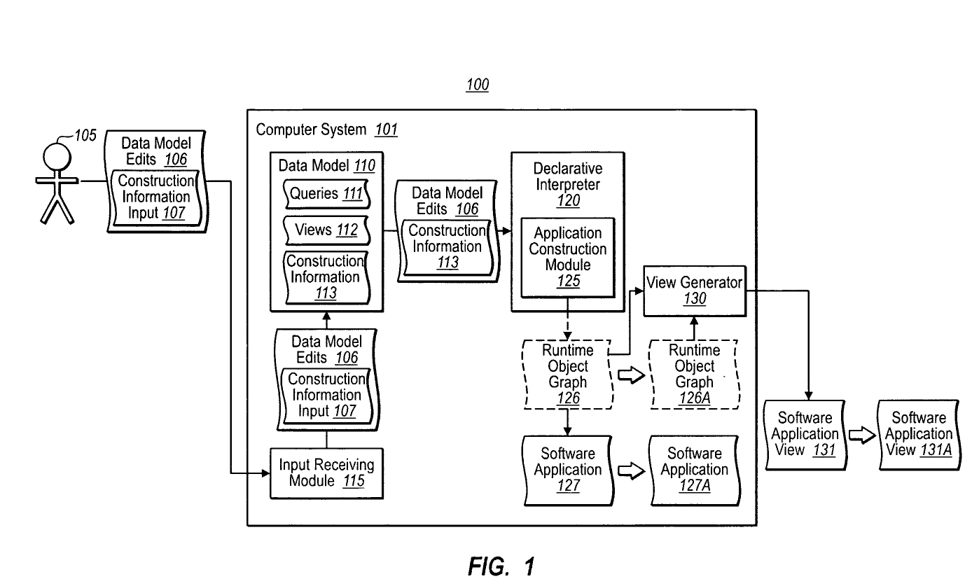

FIG. 1 illustrates a computer architecture 100 in which the principles of the present invention may be employed. Computer architecture 100 includes computer system 101. In some embodiments, computer system 101 may be include data model 110 with queries 111, views 112 and user-configurable construction information 113. Data model 110 may be any type of data model including flow diagrams, process flows, flowcharts, process diagrams and/or control charts. Additionally or alternatively, data model 110 may include templates, schemas and/or domain specific language (DSL) code portions. Queries 111 may refer to any type of data query including strings, searches, data item requests or other types of query. Queries 111 may be directly related to the data model they are part of (e.g. queries 111 are part of data model 110) or, alternatively, the queries may be related to other data models and even other computer systems.

Views 112 may refer to any type of display or view based on a model. In some embodiments, view 112 may be directly related to or generated from data in data model 110. Additionally or alternatively, view 112 may be generated from data in another model or from user-configurable construction information 113. Construction information 113 may be any type of information or instructions describing how to construct a software application based on a data model. For example, all or a portion of software application 127 may be generated by application construction module 125 based on user-configurable construction information 113 in data model 110. In some embodiments, user-configurable construction information may be received from user 105. This construction information input 107 may be received by input receiving module 115 and may be part of data model edits 106.

Software application 127A, runtime object graph 126A and software application view 131A may refer to a changed or updated version of the original object. For example, declarative interpreter 120 may receive data model edits from user 105 which the interpreter may use to update runtime object graph 126 and/or software application 127, resulting in objects 126A and 127A respectively. Similarly, view generator 130 may determine that runtime object graph 126 has been updated and, based on the updated graph, may generate an updated software application view 131A. Thus, as used herein, references to 126, 127 and/or 131 typically refer to existing objects and 126A, 127A and 131A typically refer to updated or edited objects.

Input receiving module 115 may be configured to receive other forms of user input such as data model edits 106. Input receiving module 115 may also be configured to store, at least temporarily, received inputs. Thus, construction information input 107 and data model edits 106 sent from input receiving module 115 may differ from those received as inputs (e.g. 106 & 107). In some cases, input receiving module 115 may simply receive inputs and pass them on directly to either or both of data model 110 and declarative interpreter 120.

Declarative interpreter 120 may be any software application, logic or other processing means capable of interpreting data models, queries, views, construction information and/or data model edits. Declarative interpreter 120 may be configured to interpret and process instructions based on a user's intent. For example, a user may indicate an intent to have a set of information organized in tabular form. Declarative interpreter 120 may then analyze the data set and determine the best way to present the set in tabular form. Many other variations are possible. Intent indications may come from users, other software application and/or other computer systems. Furthermore, once an intent has been declared for a data set, when changes are made to that data set, declarative interpreter 120 may dynamically and automatically update the presentation or interpretation of the data set based on the declared intent.

In some embodiments, declarative interpreter 120 may be configured to declaratively interpret data model 110 and determine how an application is to be constructed based on the model. For example, declarative interpreter 120 may interpret a DSL code portion and determine how to construct a runtime object graph (e.g. 126) based on the DSL code portion. Declarative interpreter 120 may further be configured to determine how to generate a software application (or portion thereof) based on the DSL code portion. In some cases, declarative interpreter 120 may be capable of performing such a determination without any procedural code that would be used to translate the DSL into a more generic, usable form.

Declarative interpreter 120 may also include application construction module 125 which may be used to construct a runtime object graph 126 and/or a software application 127 based on the interpretation of the data model. View generator 130 may be used to generate software application view 131 based on runtime object graph 126. For example, user 105 may wish to view all or portions of data model 110 and/or changes made to the data model in the form of data model edits 106. Declarative interpreter may interpret the data model and use application construction module 125 to construct a runtime object graph 126 of the model with the updated changes as indicated in data model edits 106. Runtime object graph 126 may serve as the basis for software application 127 and/or software application view 131, as generated by view generator 130.

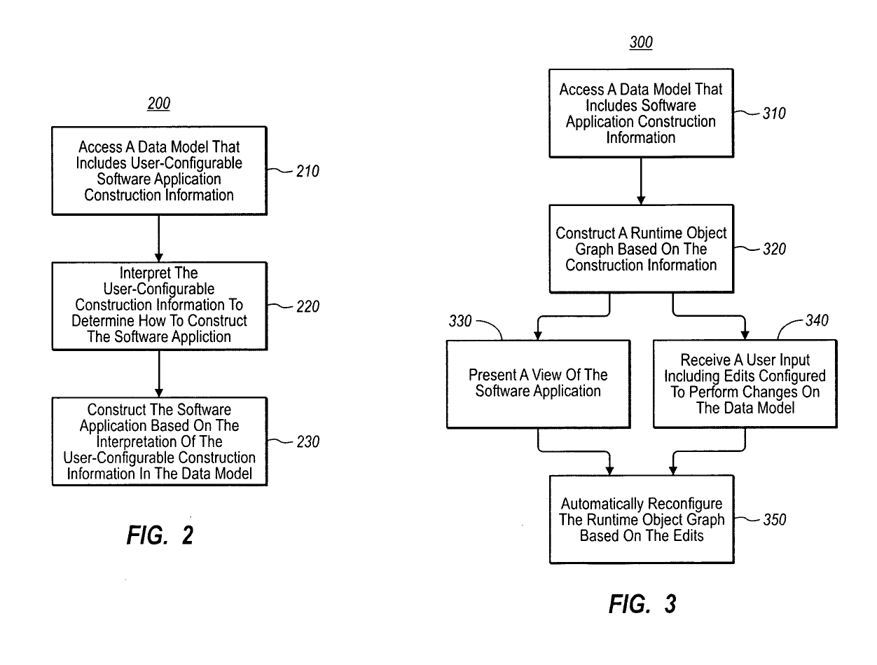

FIG. 2 illustrates a flowchart of a method 200 for constructing at least a portion of a software application based on one or more data models. The method 200 will now be described with frequent reference to the components and data of environment 100.

Method 200 includes an act of accessing a data model, where the data model includes user-configurable construction information indicating how at least a portion of a software application is to be constructed, and where the declarative interpreter is configured to construct an application based on the user-configurable construction information in the data model (act 210). For example, declarative interpreter 120 may access data model 110, where data model 110 includes user-configurable construction information 113 indicating how at least a portion of software application 127 is to be constructed. Declarative interpreter 120 may be configured to construct software application 127 based on user-configurable construction information 113 in data model 110.

In some cases, the data to be edited and/or viewed from the data model may itself describe how data is to be edited and/or viewed (i.e. the data includes construction information). This data may be used in the process of constructing the object graph (e.g. runtime object graph 126), and in such cases, only the data (and not the construction information) is viewed and/or edited by the resulting object graph. In parallel, there may be a view of the construction information that can also be edited, thus changing the object graph.

In some cases, construction information 113 may be written in a domain specific language (DSL) specialized for a particular application. Declarative interpreter 120 may be configured to interpret the construction information without the use of any procedural code to translate the DSL model. In some cases, declarative model interpreter 120 may itself be written in extensible markup language (XML) Application Framework (XAF) Application Definition (XAD) language. XAD is a declarative language used to author XAF applications such as, in this case, declarative interpreter 120. In some cases, where some portions of declarative interpreter 120 are written in XAD, those portions may include declarations indicating how to create a graph of queries and views (e.g. runtime object graph 126) based on user-configurable construction information 113 in data model 110.

XAF is a software application framework for generating a runtime structure for a given software application and for managing execution of the software application. An application generated by an application framework that includes a collection or graph of connected application components. Functionalities of an application configured according to the application framework are enabled by dynamically configuring groups of application components into component domains where each domain is configured to enable a given functionality of the application, for example, displaying a picture in a word processing document.

In order to generate a runtime structure for the application, an application may pass an application description for each required application functionality to an application description engine. The application description provides declarative rules for structuring and composing the component domains, and the application description engine is operative to interpret the declarative rules for creating and reconfiguring the component domains as required based on data events received by the application. While XML may be used within the application framework to provide a standard and simple means of stating actions or other occurrences within the framework, the application framework is not limited to the use of only XML.

In some cases, the XAF runtime may be configured to track dependencies such that data evaluations and object graph constructions may be incrementally updated when data changes. For example, the XAF runtime may track dependencies in data model 110 such that software application 127 and/or runtime object graph 126 may be incrementally updated when data in data model 110 and/or construction information 113 is updated. In some embodiments, this incremental updating is carried out automatically by the XAF runtime.

The application description engine interprets the application description for each required functionality and then obtains application components needed to construct a component domain for each required functionality. According to one embodiment, the application description engine obtains application components from a component library maintained in association with the application.

XAD is a declarative or descriptive language for authoring data flows, bindings, and rules that characterize applications. In some embodiments, XAD is used to author XAF applications based on the XAF platform. Other aspects of XAD relate to a runtime engine, which, at runtime, processes or executes the declarative application, i.e., “application description” to create objects (via builders) which view and/or process data. Using XAD, a developer need not write the actual code for the objects that do the data processing, but need only write the declarative application file that is ultimately compiled and executed. Furthermore, XAD offers progressive levels of abstraction to assist in design, strong typing, a high degree of static checking, and a high degree of extensibility. XAD also allows manipulation of heterogeneous data. Although XAF and XAD are mentioned herein and may be incorporated in one or more embodiments, it will be understood by one skilled in the art that functionality provided by either or both of XAD and XAF may additionally or alternatively be provided by other software applications, computer systems, or functionality providing entities.

In some embodiments, declarative interpreter 120 may be configured to interpret hints. Hints may be any type of information stored in a data model that would indicate or influence how applications based on the model are to be constructed. For example, data model 110 may include hints that indicate how a user interface for any applications based on data model 110 should look. Additionally or alternatively, declarative interpreter 120 may be configured to interpret structural mappings. Such structural mappings, like hints, may influence certain structural items within an application based on a data model with those structural mappings.

In some cases, a user may input construction information into the data model indicating how the software application is to be constructed. For example, user 105 may input construction information input 107 which is received by input receiving module 115 and passed on to data model 110. Construction information input 107 may be generated by user 105 or may be selected from a group of options presented to the user. Construction information input 107 may be used to overwrite or supplement user-configurable construction information 113 in data model 110. In some cases, software application 127 may also be based on more than one data model. In such cases, data models may be accessed from a repository in which additional data models are stored.

Method 200 also includes an act of interpreting the construction information in the data model to determine how to construct at least a portion of the software application (act 220). For example, declarative interpreter 120 may interpret user-configurable construction information 113 in data model 110 to determine how to construct at least a portion of software application 127. As described above, in some cases application construction module 125 may construct a data flow graph (e.g. runtime object graph 126) based on user-configurable construction information 113. Furthermore, view generator 130 may generate one or more views (e.g. software application view 131) based on the data flow graph. Such views may be bound to the data in the data model as they are generated based on declarative interpreter's interpretation of data model 110. Moreover, view 121 and/or application 127 may be altered by any hints, structural mappings, or other construction information input 107 input by user 105 before construction of the view/application. In some cases, such altering and other updating may be performed automatically by an underlying XAF platform.

Method 200 includes an act of constructing at least a portion of the software application based on the interpretation of the construction information in the data model (act 230). For example, application construction module 125 may construct at least a portion of software application 127 based on the declarative interpreter's interpretation of user-configurable construction information 113 in data model 110. As indicated previously, declarative interpreter 120 may receive user input indicating one or more changes that are to be made to the data model. In some embodiments, these changes (e.g. data model edits 106) may be automatically applied as to the model, which are then carried to the software application which is based on the data model. Such an automatic application of inputs may occur at runtime (i.e. during either of the interpretation by declarative interpreter 120 or the generation of the application 127A by application construction module 125).

Some embodiments may include the further creation of a user interface for software application 127 based on data model 110. For example, application construction module 125 may generate a user interface for software application 127 based on the declarative interpreter's interpretation of data model 110. Additionally or alternatively, services may be generated in the same manner, also based on data model 110. The services may include web services, information retrieval services or other types of services based on one or more portions of data model 110.

FIG. 3 illustrates a flowchart of a method 300 for automatically reconfiguring a runtime object graph according to one or more data model edits input by a user. The method 300 will now be described with frequent reference to the components and data of environment 100.

Method 300 includes an act of accessing a data model, where the data model includes construction information indicating how at least a portion of a software application is to be constructed (act 310). For example, declarative interpreter 120 may access data model 110, where data model 110 includes user-configurable construction information 113 indicating how at least a portion of software application 127 is to be constructed. In some embodiments, a data model may describe a business rule or process. For example, the business process may describe how to perform a credit check. User 105 may desire to change how the credit check is performed and may input data model edits 106 which are used to change the data model. Declarative interpreter 120 may then alter its interpretation of data model 110 and send the interpretation to application construction module 125 which generates the application based on the new interpretation. In some cases, updated application 127A may be generated using the updated interpretation on the fly. This is a result of the declarative interpreter being able to interpret the data model without having to rebuild the model.

Method 300 includes an act of constructing a runtime object graph based on the construction information in the data model (act 320). For example, application construction module 125 may construct updated runtime object graph 126A based on user-configurable construction information 113 in data model 110. Runtime object graph 126A may serve as the basis for updated software application 127A and/or updated software application view 131A.

Method 300 includes an act of presenting a view of the software application based on the runtime object graph (act 330). For example, view generator 130 may present software application view 131 based on runtime object graph 126. View 131 may be a view of only a portion of data model 110 and/or runtime object graph 126. Alternatively, view 131 may present a view of each aspect of data model 110. Software application view 131 may also be the result of a query (e.g. query 111) for certain items in data model 110. For example, user 105 may query for those information items necessary to perform a credit check. Thus, in such a scenario, view generator 130 may generate a view specifically for those information items identified in the user's query.

Method 300 includes an act of receiving a user input including one or more edits configured to perform changes on the data model (act 340). For example, input receiving module 115 may receive data model edits 106 configured to perform changes on data model 110. Edits to data model 110 (e.g. data model edits 106) may include any type of informational, structural, layout, presentation, user interface or any other types of changes that can be applied to a data model.

Method 300 includes an act of automatically reconfiguring the runtime object graph based on the edits such that the runtime object graph reflects the changes input by the user as indicated in the edits (act 350). For example, declarative interpreter 120 may automatically reconfigure runtime object graph 126 based on data model edits 106 such that updated runtime object graph 126A reflects the changes input by user 105 as indicated in data model edits 106. Thus, any edits input by user 105 may be automatically applied to updated runtime object graph 126A, which in some embodiments serves as the basis for updated software application 127A and/or updated software application view 131A. Thus, from an end-user's perspective, the end-user may input changes to a data model and see the changes automatically applied to the intended application. As mentioned above, automatic updating and/or reconfiguring may be performed automatically by an underlying XAF platform.

In some embodiments, a default method for displaying objects of the data model may be established. For example, user 105 may specify a default method for displaying data model objects such as specifying a default color scheme, layout scheme, data presentation scheme or other method for displaying data model objects. In some cases, the default display method may be a property set display where the properties of different data model objects are displayed. In other cases, the default display method may be determined by declarative interpreter 120 based on a determination of which display type would be appropriate for the data model in its current form.

Thus, in summary, at least a portion of a software application may be constructed based on one or more data models such as data model 110. Furthermore, a runtime object graph may be automatically reconfigured according to one or more data model edits input by a user such as user 105.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system with a declarative interpreter configured to construct software applications from one or more data models, a method for constructing at least a portion of a software application based on one or more data models, the method comprising:
an act of the declarative interpreter accessing a data model, the data model including user-configurable construction information indicating how at least a portion of a software application is to be constructed, the declarative interpreter being configured to construct an application based on the user-configurable construction information in the data model;
an act of the declarative interpreter interpreting the user-configurable construction information in the data model to determine how to construct at least a portion of the software application; and
an act of the declarative interpreter constructing at least a portion of the software application based on the interpretation of the user-configurable construction information in the data model.

2. The method of claim 1, wherein a user inputs user-configurable construction information into the data model indicating how the software application is to be constructed.

3. The method of claim 1, further comprising:
an act of receiving a user input indicating one or more changes that are to be made to the data model; and
an act of automatically applying the one or more changes made to the model to the software application which is based on the data model.

4. The method of claim 3, wherein the model is modified at runtime.

5. The method of claim 1, wherein at least a portion of the declarative interpreter is written in XAD.

6. The method of claim 5, wherein the portions of the declarative interpreter written in XAD comprise declarations indicating how to create a graph of queries and views based on the user-configurable construction information in the data model.

7. The method of claim 1, further comprising receiving one or more data models from a repository in which the data models are stored.

8. The method of claim 1, wherein the act of the declarative interpreter interpreting the user-configurable construction information in the data model comprises:
an act of constructing a data flow graph from the data model;
an act of creating one or more views based on the data flow graph; and
an act of binding the views to the data in the data model.

9. The method of claim 1, wherein the declarative interpreter is further configured to interpret hints.

10. The method of claim 1, wherein the declarative interpreter is further configured to interpret structural mappings.

11. The method of claim 1, further comprising an act of creating a user interface for the software application based on the data model.

12. The method of claim 1, further comprising an act of creating a service for the software application based on the data model.

13. The method of claim 1, wherein the data model is written in a domain specific language (DSL) specialized for a particular application.

14. In a computing system, a method for automatically reconfiguring a runtime object graph according to one or more data model edits input by a user, the method comprising:
an act of accessing a data model, the data model including construction information indicating how at least a portion of a software application is to be constructed;
an act of constructing a runtime object graph based on the construction information in the data model;
an act of presenting a view of the software application based on the runtime object graph;
an act of receiving a user input including one or more edits configured to perform changes on the data model; and
an act of automatically reconfiguring the runtime object graph based on the edits such that the runtime object graph reflects the changes input by the user as indicated in the edits.

15. The method of claim 14, further comprising presenting a view of the software application based on the reconfigured runtime object graph.

16. The method of claim 15, further comprising establishing a default method for displaying objects of the data model.

17. The method of claim 16, wherein the default display method comprises a property set display.

18. A computer program product for implementing a method for constructing at least a portion of a software application based on one or more data models, the computer program product comprising one or more computer-readable media having thereon computer-executable instructions that, when executed by one or more processors of the computing system, cause the computing system to perform the method, the method comprising:
an act of the declarative interpreter accessing a data model, the data model including user-configurable construction information indicating how at least a portion of a software application is to be constructed, the declarative interpreter being configured to construct an application based on the user-configurable construction information in the data model;
an act of the declarative interpreter interpreting the user-configurable construction information in the data model to determine how to construct at least a portion of the software application; and
an act of the declarative interpreter constructing at least a portion of the software application based on the interpretation of the user-configurable construction information in the data model.

19. The computer program product of claim 18, further comprising:
an act of receiving a user input indicating one or more changes that are to be made to the data model; and
an act of automatically applying the one or more changes made to the model to the software application which is based on the data model.

20. The method of claim 1, wherein the act of the declarative interpreter interpreting the user-configurable construction information in the data model comprises:
an act of constructing a data flow graph from the data model;
an act of creating one or more views based on the data flow graph; and
an act of binding the views to the data in the data model.
